(19) United States
(12) Patent Application Publication
(10) Pub. No.: US 2024/0292207 A1
(43) Pub. Date: Aug. 29, 2024

(54) PHYSICAL CELL IDENTIFIER MANAGEMENT

(71) Applicant: QUALCOMM Incorporated, San Diego, CA (US)

(72) Inventors: Naeem AKL, Bridgewater, NJ (US); Karl Georg HAMPEL, Jersey City, NJ (US)

(21) Appl. No.: 18/392,442

(22) Filed: Dec. 21, 2023

Related U.S. Application Data
(60) Provisional application No. 63/487,139, filed on Feb. 27, 2023.

(51) Int. Cl. H04W 8/26; H04W 24/02

(52) U.S. Cl. CPC H04W 8/26; H04W 24/02

(57) ABSTRACT

Various aspects of the present disclosure generally relate to wireless communication. In some aspects, a distributed unit (DU) associated with an integrated access and backhaul (IAB)-node may transmit, and a central unit (CU) may receive, a restriction indication that indicates a restriction for a physical cell identifier (PCI) configuration of a cell that is served by the DU. The restriction indication may include, for example, one or more PCI values that are not to be used for the PCI configuration of the cell, and/or may include one or more PCI values that are allowed to be used for the PCI configuration of the cell. The CU may transmit, and the DU may receive, a PCI configuration of the cell that is in accordance with the restriction indication. Numerous other aspects are described.

### CROSS-REFERENCE TO RELATED APPLICATION

This Patent Application claims priority to U.S. Provisional Patent Application No. 63/487,139, filed on Feb. 27, 2023, entitled “PHYSICAL CELL IDENTIFIER MANAGEMENT,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically, to techniques and apparatuses for physical cell identifier management.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different user equipments (UEs) to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In some cases, an integrated access and backhaul (IAB)-node may establish one or more F1 connections with one or more donor-central units (CUs), respectively, where each donor-CU instantiates a logical IAB-distributed unit (DU) on the IAB-node. For each F1 connection, the respective IAB-DU may report a list of served cells to the corresponding donor-CU. For example, IAB-DU1 may report a cell1 to CU1, and IAB-DU2 may report a cell2 to CU2. Cell1 and cell2 may use different physical cell identifiers (PCIs), for example, if cell1 and cell2 are associated with the same carrier. In some cases, the PCI of an IAB-DU cell may be configured (for example, reconfigured) by an F1-terminating CU. For example, the PCI of cell1 may be reconfigured by CU1 and the PCI of cell2 may be reconfigured by CU2. If cell1 and cell2 use the same carrier, one CU may reconfigure the PCI of its associated cell to the same PCI value of the other cell. This may result in increased interference, an increased likelihood of PCI collision for connected UEs, and/or an increased likelihood of UE handover failure during a full migration between cells.

### SUMMARY

Some aspects described herein relate to a method for wireless communication by a distributed network node. The method may include transmitting, to a central network node, a restriction indication that indicates a restriction for a physical cell identifier (PCI) configuration of a cell that is served by the distributed network node, the distributed network node being associated with an integrated access and backhaul node. The method may include receiving, from the central network node, a PCI configuration of the cell that is in accordance with the restriction indication.

Some aspects described herein relate to a method for wireless communication by a central network node. The method may include receiving, from a distributed network node associated with an integrated access and backhaul node, a restriction indication that indicates a restriction for a PCI configuration of a cell that is served by the distributed network node. The method may include transmitting, to the distributed network node, a PCI configuration of the cell that is in accordance with the restriction indication.

Some aspects described herein relate to a distributed network node for wireless communication. The distributed network node may include a processing system that includes one or more processors and one or more memories coupled with the one or more processors. The processing system may be operable to cause the distributed network node to transmit, to a central network node, a restriction indication that indicates a restriction for a PCI configuration of a cell that is served by the distributed network node, the distributed network node being associated with an integrated access and backhaul node. The processing system may be operable to cause the distributed network node to receive, from the central network node, a PCI configuration of the cell that is in accordance with the restriction indication.

Some aspects described herein relate to a central network node for wireless communication. The central network node may include a processing system that includes one or more processors and one or more memories coupled with the one or more processors. The processing system may be operable to cause the central network node to receive, from a distributed network node associated with an integrated access and backhaul node, a restriction indication that indicates a restriction for a PCI configuration of a cell that is served by the distributed network node. The processing system may be operable to cause the central network node to transmit, to the distributed network node, a PCI configuration of the cell that is in accordance with the restriction indication.

Some aspects described herein relate to a non-transitory computer-readable medium that stores a set of instructions for wireless communication by a distributed network node. The set of instructions, when executed by one or more processors of the distributed network node, may cause the distributed network node to transmit, to a central network node, a restriction indication that indicates a restriction for a PCI configuration of a cell that is served by the distributed network node, the distributed network node being associated with an integrated access and backhaul node. The set of instructions, when executed by one or more processors of the distributed network node, may cause the distributed network node to receive, from the central network node, a PCI configuration of the cell that is in accordance with the restriction indication.

Some aspects described herein relate to a non-transitory computer-readable medium that stores a set of instructions for wireless communication by a central network node. The set of instructions, when executed by one or more processors of the central network node, may cause the central network node to receive, from a distributed network node associated with an integrated access and backhaul node, a restriction indication that indicates a restriction for a PCI configuration of a cell that is served by the distributed network node. The set of instructions, when executed by one or more processors of the central network node, may cause the central network node to transmit, to the distributed network node, a PCI configuration of the cell that is in accordance with the restriction indication.

Some aspects described herein relate to an apparatus for wireless

communication. The apparatus may include means for transmitting, to a central network node, a restriction indication that indicates a restriction for a PCI configuration of a cell that is served by the apparatus, the apparatus being associated with an integrated access and backhaul node. The apparatus may include means for receiving, from the central network node, a PCI configuration of the cell that is in accordance with the restriction indication.

Some aspects described herein relate to an apparatus for wireless

communication. The apparatus may include means for receiving, from a distributed network node associated with an integrated access and backhaul node, a restriction indication that indicates a restriction for a PCI configuration of a cell that is served by the distributed network node. The apparatus may include means for transmitting, to the distributed network node, a PCI configuration of the cell that is in accordance with the restriction indication.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating examples of radio access networks in accordance with the present disclosure.

FIG. 5 is a diagram illustrating an example of an integrated access and backhaul (IAB) network architecture in accordance with the present disclosure.

FIGS. 6A-6B are diagrams illustrating examples of distributed unit migration in accordance with the present disclosure.

FIG. 7 is a diagram illustrating an example of a physical cell identifier (PCI) value for a cell connected to an IAB node in accordance with the present disclosure.

FIG. 8 is a diagram illustrating an example of PCI management in accordance with the present disclosure.

FIG. 9 is a diagram illustrating an example of PCI values for a plurality of cells connected to an IAB node in accordance with the present disclosure.

FIG. 10 is a flowchart illustrating an example process performed, for example, by a distributed network node that supports PCI management in accordance with the present disclosure.

FIG. 11 is a flowchart illustrating an example process performed, for example, by a central network node that supports PCI management in accordance with the present disclosure.

FIG. 12 is a diagram of an example apparatus for wireless communication that supports PCI management in accordance with the present disclosure.

FIG. 13 is a diagram of an example apparatus for wireless communication that supports PCI management in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A radio access network may include a wireless backhaul network, sometimes referred to as an integrated access and backhaul (IAB) network. In an IAB network, at least one network node may be an anchor network node that communicates with a core network via a wired backhaul link. The anchor network node that communicates with the core network via the wired backhaul link may be referred to as an IAB donor. The IAB network may additionally include one or more non-anchor network nodes. The non-anchor network nodes may be referred to as relay network nodes or IAB nodes. In some cases, the IAB donor may include a central unit (CU), which may perform access node controller (ANC) functions and/or access and mobility management (AMF) functions. The CU may configure a distributed unit (DU) of the IAB donor and/or may configure one or more IAB nodes that connect to the core network via the IAB donor. Thus, a CU of an IAB donor may control and/or configure the entire IAB network that connects to the core network via the IAB donor, such as by using control messages and/or configuration messages (for example, radio resource control (RRC) configuration messages or F1 application protocol (F1-AP) messages).

In some examples, a single IAB node may establish a plurality of F1

connections with a plurality of respective donor CUs, where each donor CU instantiates a logical IAB DU on the IAB node. For each F1 connection, the respective IAB DU may report a list of served cells to the corresponding donor CU. For example, IAB DU1 may report a cell1 to CU1, and IAB DU2 may report a cell2 to CU2. Cell1 and cell2 may use different physical cell identifiers (PCIs), for example, if cell1 and cell2 are associated with the same carrier. In some cases, a PCI of an IAB DU cell may be reconfigured by an F1-terminating CU. For example, the PCI of cell1 may be reconfigured by CU1 and the PCI of cell2 may be reconfigured by CU2. If cell1 and cell2 use the same carrier, one CU may reconfigure the PCI of its associated cell to the same PCI value of the other cell. Multiple cells having the same PCI for the same carrier may result in increased interference, an increased likelihood of PCI collision, and/or an increased likelihood of UE handover failure during a full migration between cells.

Various aspects generally relate to PCI management. Some aspects more specifically relate to reporting restricted PCI value(s) or allowed PCI value(s) for a PCI configuration of a cell. In some aspects, a DU associated with an IAB node may transmit, and a CU may receive, a restriction indication that indicates a restriction for a PCI configuration of a cell that is served by the DU. The restriction indication may include one or more PCI values that are not to be used for the PCI configuration of the cell. For example, the restriction indication may include a list of PCI values that are not to be used for the PCI configuration of the cell. Additionally, or alternatively, the restriction indication may include one or more PCI values that are allowed to be used for the PCI configuration of the cell. The CU may transmit, and the DU may receive, a PCI configuration of the cell that is in accordance with the restriction indication. For example, the CU may transmit a PCI configuration of a cell that does not include a PCI value that is included in the one or more PCI values that are not to be used for the PCI configuration of the cell and/or that includes a PCI value that is included in the one or more PCI values that are allowed to be used for the PCI configuration of the cell. In some aspects, the DU may transmit a subsequent PCI restriction indication that includes an updated restriction for the PCI configuration of the cell. The DU may transmit the subsequent PCI restriction indication in accordance with the DU adding or deleting another cell having a PCI value associated with the updated restriction, in accordance with the DU activating or deactivating another cell having the PCI value associated with the updated restriction, and/or in accordance with the DU reconfiguring a PCI value for another cell that is served by the DU.

Particular aspects of the subject matter described in this disclosure can be implemented to realize one or more of the following potential advantages. In some examples, by enabling the DU to transmit the restriction indication to the CU, the described techniques can be used to reduce interference for communications within a cell associated with the restriction indication. In some examples, by enabling the DU to transmit the restriction indication to the CU, the described techniques can be used to reduce a likelihood of PCI collision for user equipments (UEs) connected to the cell. In some examples, by enabling the DU to transmit the restriction indication to the CU, the described techniques can be used to reduce a likelihood of UE handover failure during a migration between cells. These example advantages, among others, are described in more detail below.

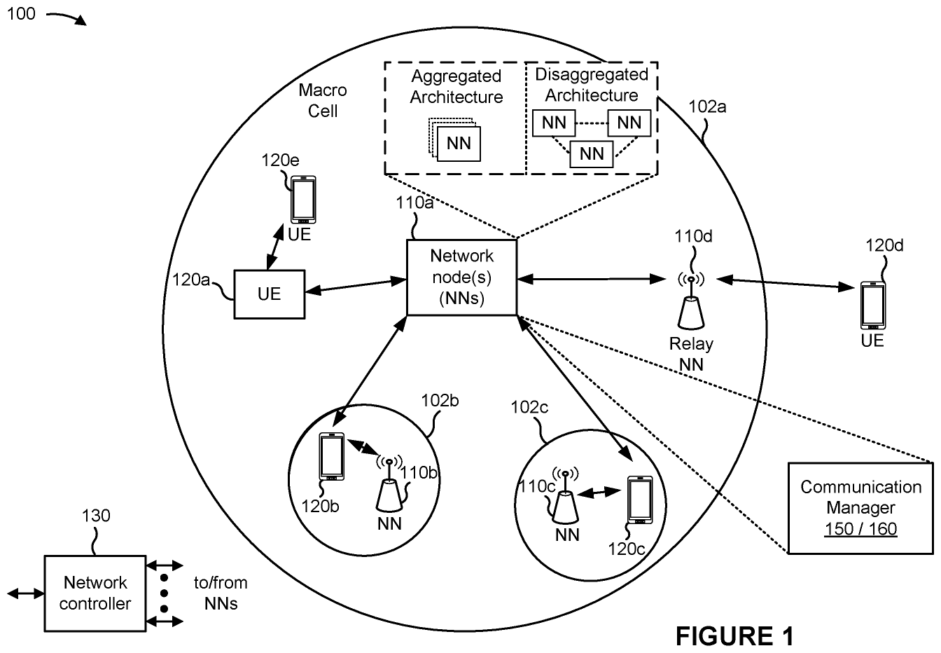

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more CUs, one or more DUs, or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an IAB node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a DU of the network node 110 may include a communication manager 150. As described in more detail elsewhere herein, the communication manager 150 may transmit, to a CU, a restriction indication that indicates a restriction for a PCI configuration of a cell that is served by the DU, the DU being associated with an IAB node; and receive, from the CU, a PCI configuration of the cell that is based on or otherwise associated with the restriction indication. Additionally or alternatively, the communication manager 150 may perform one or more other operations described herein.

In some aspects, a CU of the network node 110 may include the communication manager 160. As described in more detail elsewhere herein, the communication manager 160 may receive, from a DU associated with an IAB node, a restriction indication that indicates a restriction for a PCI configuration of a cell that is served by the DU; and transmit, to the DU, a PCI configuration of the cell that is based on or otherwise associated with the restriction indication. Additionally or alternatively, the communication manager 160 may perform one or more other operations described herein.

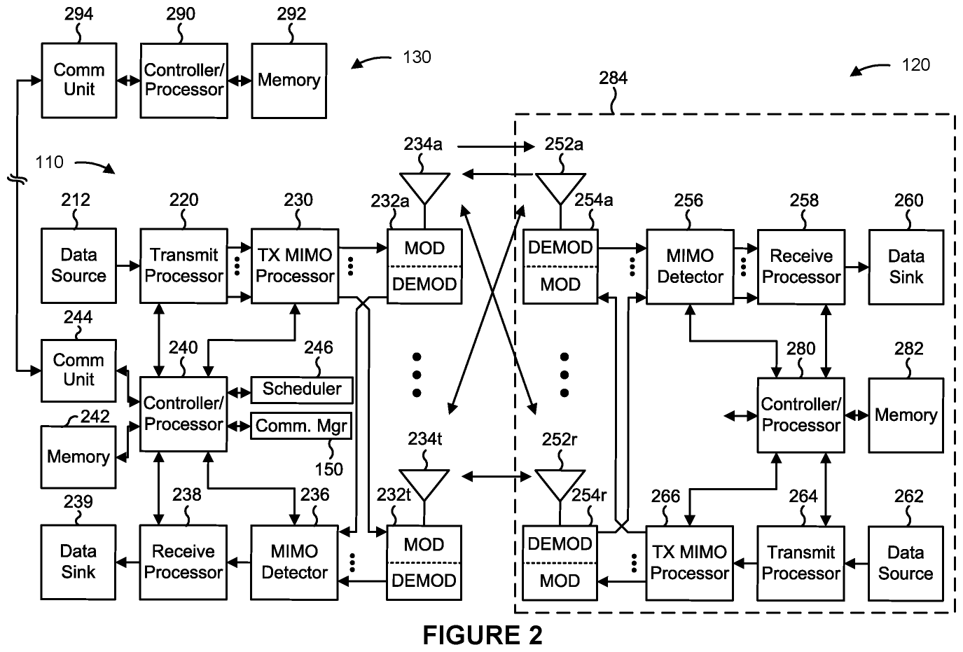

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based on or otherwise associated with one or more channel quality indicators (CQIs) received from that UE 120. The network node 110 may process (for example, encode and modulate) the data for the UE 120 based on or otherwise associated with the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

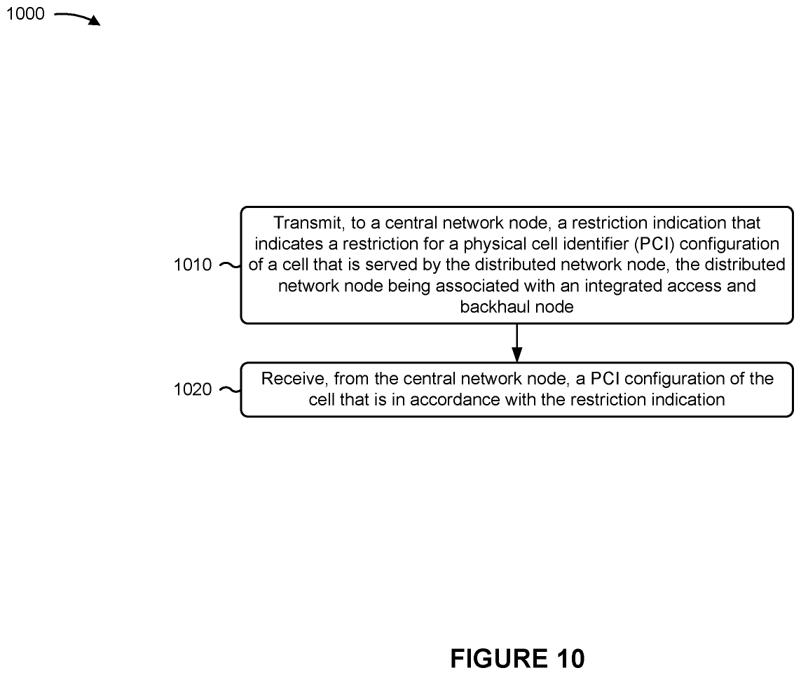

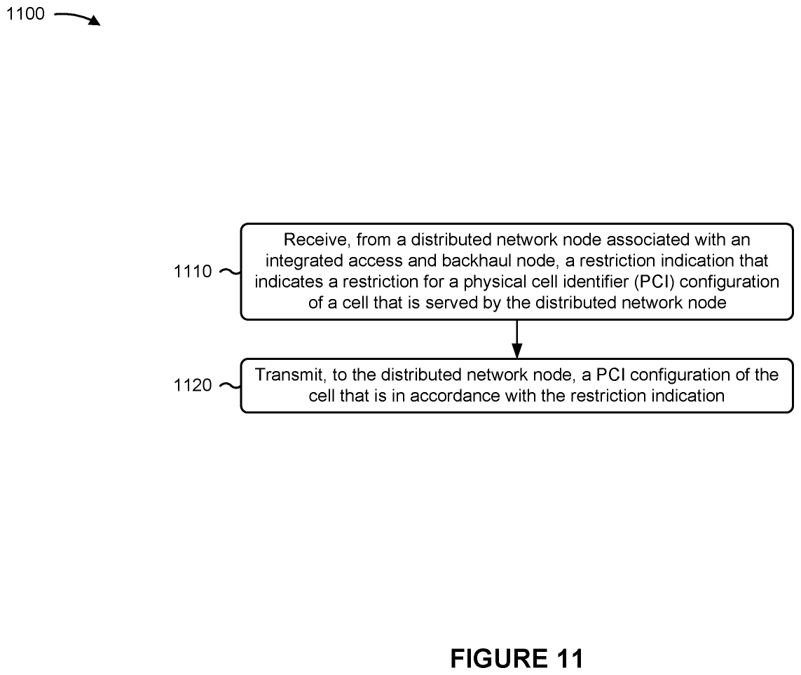

The controller/processor 240 of the network node 110, the controller/processor 280 of the UE 120, or any other component(s) of FIG. 2 may perform one or more techniques associated with PCI management, as described in more detail elsewhere herein. For example, the controller/processor 240 of the network node 110, the controller/processor 280 of the UE 120, or any other component(s) of FIG. 2 may perform or direct operations of, for example, process 1000 of FIG. 10, process 1100 of FIG. 11, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1000 of FIG. 10, process 1100 of FIG. 11, or other processes as described herein. In some examples, executing instructions may include running the instructions, converting the instructions, compiling the instructions, or interpreting the instructions, among other examples.

In some aspects, a distributed network node includes means for transmitting, to a central network node, a restriction indication that indicates a restriction for a PCI configuration of a cell that is served by the distributed network node, the distributed network node being associated with an IAB node; and/or means for receiving, from the central network node, a PCI configuration of the cell that is based on or otherwise associated with the restriction indication. The means for the distributed network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a central network node includes means for receiving, from a distributed network node associated with an IAB node, a restriction indication that indicates a restriction for a PCI configuration of a cell that is served by the distributed network node; and/or means for transmitting, to the distributed network node, a PCI configuration of the cell that is based on or otherwise associated with the restriction indication. The means for the central network node to perform operations described herein may include, for example, one or more of communication manager 160, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, and/or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

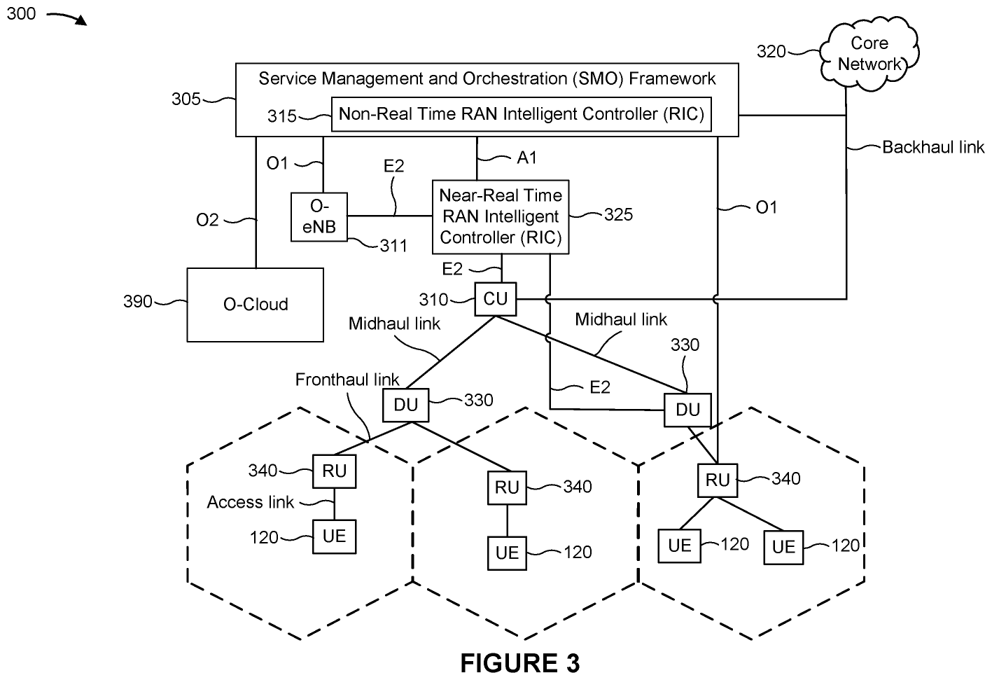

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), and/or control plane functionality (for example, Central Unit-Control Plane (CU-CP) functionality). In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

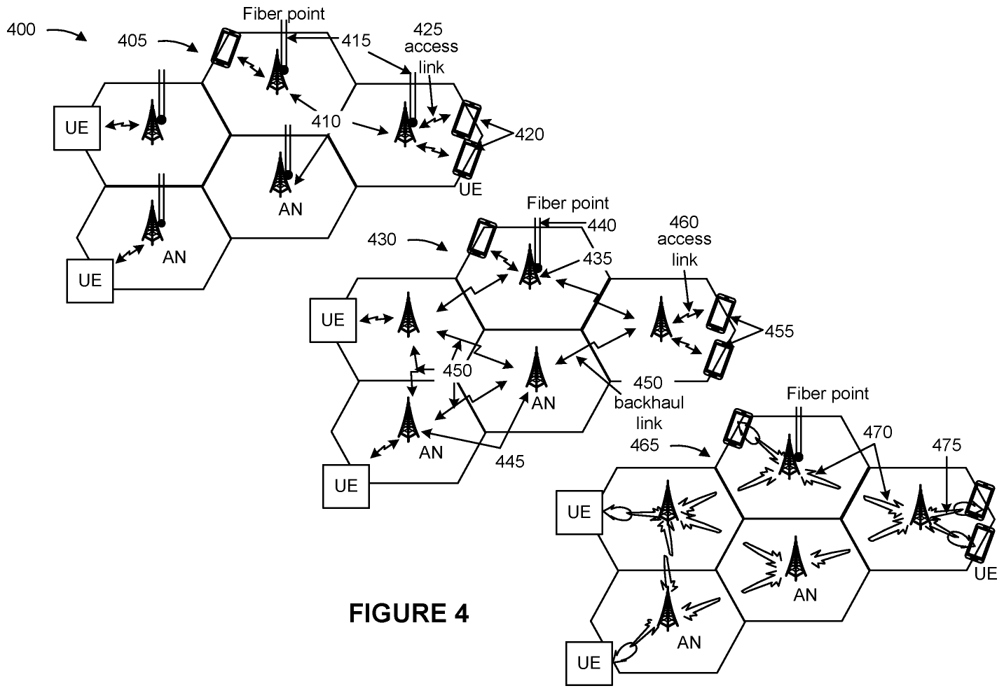

FIG. 4 is a diagram illustrating examples 400 of radio access networks in accordance with the present disclosure.

In an example operation 405, a traditional (for example, 3G, 4G, or LTE) radio access network may include multiple base stations 410 (for example, access nodes (AN)), where each base station 410 communicates with a core network via a wired backhaul link 415, such as a fiber connection. A base station 410 may communicate with a UE 420 via an access link 425, which may be a wireless link. In some cases, a base station 410 shown in FIG. 4 may be a network node 110 shown in FIG. 1. In some cases, a UE 420 shown in FIG. 4 may be a UE 120 shown in FIG. 1.

In an example operation 430, a radio access network may include a wireless backhaul network, sometimes referred to as an integrated access and backhaul (IAB) network. In an IAB network, at least one base station is an anchor base station 435 that communicates with a core network via a wired backhaul link 440, such as a fiber connection. An anchor base station 435 may also be referred to as an IAB donor (or IAB-donor). The IAB network may include one or more non-anchor base stations 445, sometimes referred to as relay base stations or IAB nodes (or IAB-nodes). The non-anchor base station 445 may communicate directly or indirectly with the anchor base station 435 via one or more backhaul links 450 (for example, via one or more non-anchor base stations 445) to form a backhaul path to the core network for carrying backhaul traffic. Backhaul link 450 may be a wireless link. Anchor base station(s) 435 and/or non-anchor base station(s) 445 may communicate with one or more UEs 455 via access links 460, which may be wireless links for carrying access traffic. In some cases, an anchor base station 435 and/or a non-anchor base station 445 shown in FIG. 4 may be a network node 110 shown in FIG. 1. In some cases, a UE 455 shown in FIG. 4 may be a UE 120 shown in FIG. 1.

In an example operation 465, in some cases, a radio access network that includes an IAB network may utilize millimeter wave technology and/or directional communications (for example, beamforming) for communications between base stations and/or UEs (for example, between two base stations, between two UEs, and/or between a base station and a UE). For example, wireless backhaul links 470 between base stations may use millimeter wave signals to carry information and/or may be directed toward a target base station using beamforming. Similarly, the wireless access links 475 between a UE and a base station may use millimeter wave signals and/or may be directed toward a target wireless node (for example, a UE and/or a base station). In this way, inter-link interference may be reduced.

The configuration of base stations and UEs in FIG. 4 is shown as an example, and other examples are contemplated. For example, one or more base stations illustrated in FIG. 4 may be replaced by one or more UEs that communicate via a UE-to-UE access network (for example, a peer-to-peer network or a device-to-device network). In this example, an anchor node may refer to a UE that is directly in communication with a base station (for example, an anchor base station or a non-anchor base station).

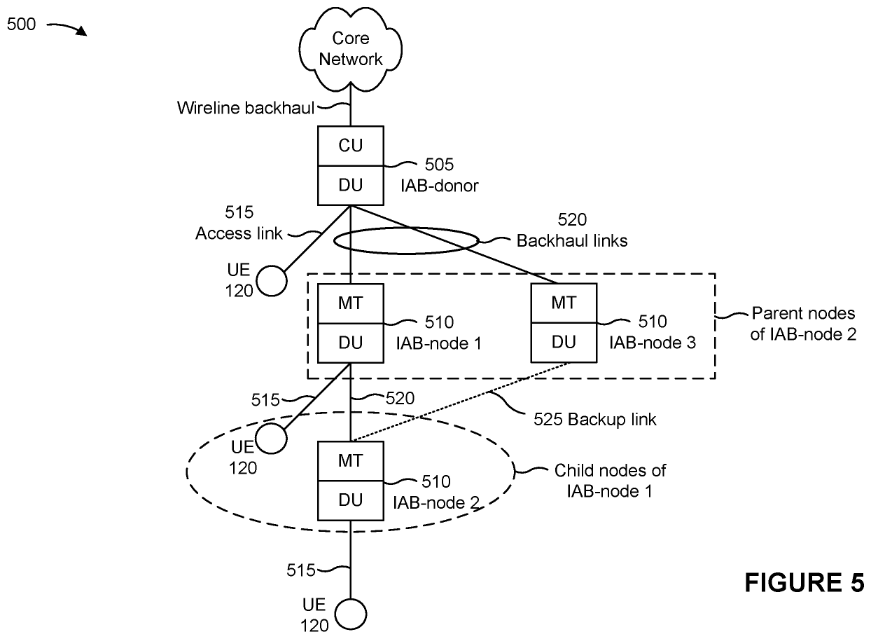

FIG. 5 is a diagram illustrating an example 500 of an IAB network architecture in accordance with the present disclosure.

As shown in FIG. 5, an IAB network may include an IAB donor 505 (shown as IAB-donor) that connects to a core network via a wired connection (shown as a wireline backhaul). For example, an Ng interface of an IAB donor 505 may terminate at a core network. Additionally or alternatively, an IAB donor 505 may connect to one or more devices of the core network that provide a core access and mobility management function (AMF). In some cases, an IAB donor 505 may include a network node 110, such as an anchor base station, as described above in connection with 4. As shown, an IAB donor 505 may include a CU, which may perform access node controller (ANC) functions and/or AMF functions. The CU may configure a DU of the IAB donor 505 and/or may configure one or more IAB nodes 510 (for example, a mobile termination (MT) and/or a DU of an IAB node 510) that connect to the core network via the IAB donor 505. Thus, a CU of an IAB donor 505 may control and/or configure the entire IAB network that connects to the core network via the IAB donor 505, such as by using control messages and/or configuration messages (for example, an RRC configuration message or an F1 application protocol (F1-AP) message).

As further shown in FIG. 5, the IAB network may include IAB nodes 510 (shown as IAB-node 1, IAB-node 2, and IAB-node 3) that connect to the core network via the IAB donor 505. As shown, an IAB node 510 may include MT functions (also sometimes referred to as UE functions (UEF)) and may include DU functions (also sometimes referred to as access node functions (ANF)). The MT functions of an IAB node 510 (for example, a child node) may be controlled and/or scheduled by another IAB node 510 (for example, a parent node of the child node) and/or by an IAB donor 505. The DU functions of an IAB node 510 (for example, a parent node) may control and/or schedule other IAB nodes 510 (for example, child nodes of the parent node) and/or UEs 120. Thus, a DU may be referred to as a scheduling node or a scheduling component, and an MT may be referred to as a scheduled node or a scheduled component. In some cases, an IAB donor 505 may include DU functions and not MT functions. That is, an IAB donor 505 may configure, control, and/or schedule communications of IAB nodes 510 and/or UEs 120. A UE 120 may include only MT functions, and not DU functions. That is, communications of a UE 120 may be controlled and/or scheduled by an IAB donor 505 and/or an IAB node 510 (for example, a parent node of the UE 120).

When a first node controls and/or schedules communications for a second node (for example, when the first node provides DU functions for the second node's MT functions), the first node may be referred to as a parent node of the second node, and the second node may be referred to as a child node of the first node. A child node of the second node may be referred to as a grandchild node of the first node. Thus, a DU function of a parent node may control and/or schedule communications for child nodes of the parent node. A parent node may be an IAB donor 505 or an IAB node 510, and a child node may be an IAB node 510 or a UE 120. Communications of an MT function of a child node may be controlled and/or scheduled by a parent node of the child node.

As further shown in FIG. 5, a link between a UE 120 (for example, which only has MT functions, and not DU functions) and an IAB donor 505, or between a UE 120 and an IAB node 510, may be referred to as an access link 515. Access link 515 may be a wireless access link that provides a UE 120 with radio access to a core network via an IAB donor 505, and optionally via one or more IAB nodes 510. Thus, the network illustrated in 5 may be referred to as a multi-hop network or a wireless multi-hop network.

As further shown in FIG. 5, a link between an IAB donor 505 and an IAB node 510 or between two IAB nodes 510 may be referred to as a backhaul link 520. Backhaul link 520 may be a wireless backhaul link that provides an IAB node 510 with radio access to a core network via an IAB donor 505, and optionally via one or more other IAB nodes 510. In an IAB network, network resources for wireless communications (for example, time resources, frequency resources, and/or spatial resources) may be shared between access links 515 and backhaul links 520. In some cases, a backhaul link 520 may be a primary backhaul link or a secondary backhaul link (for example, a backup backhaul link). In some cases, a secondary backhaul link may be used if a primary backhaul link fails, becomes congested, and/or becomes overloaded, among other examples. For example, a backup link 525 between IAB-node 2 and IAB-node 3 may be used for backhaul communications if a primary backhaul link between IAB-node 2 and IAB-node 1 fails. As used herein, a node or a wireless node may refer to an IAB donor 505 or an IAB node 510.

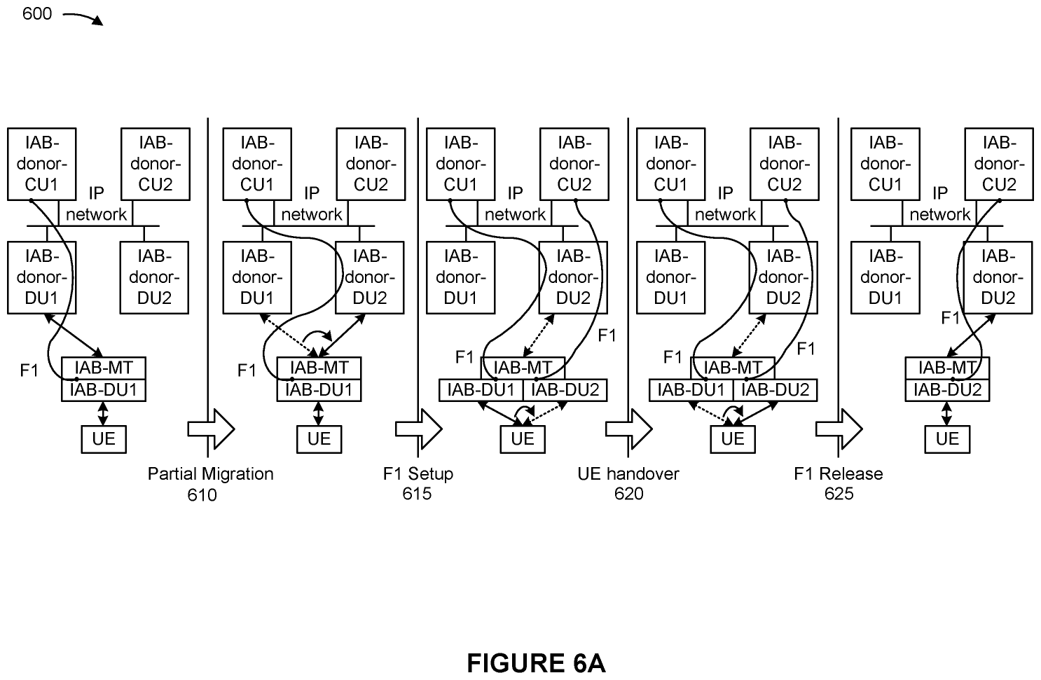

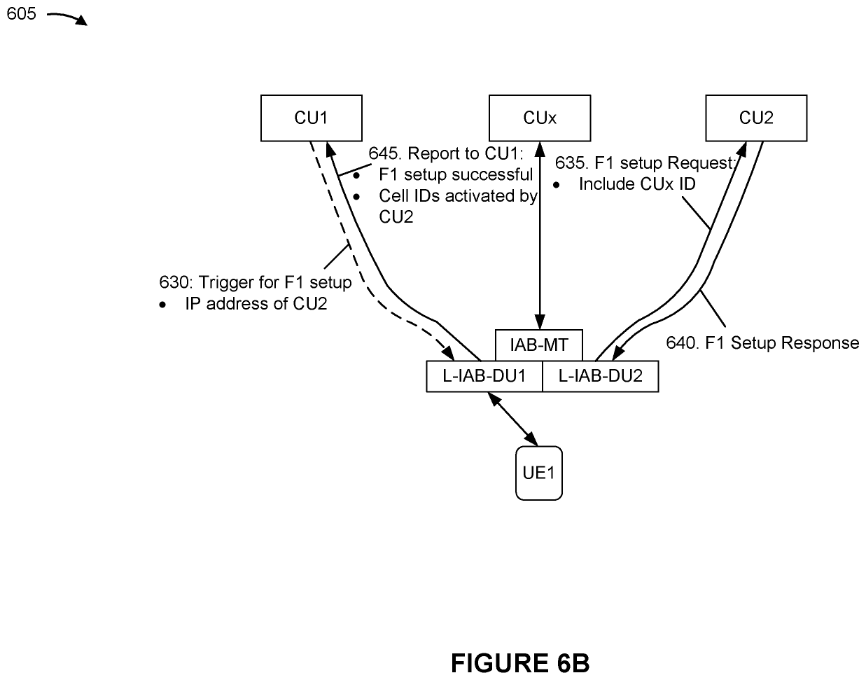

FIGS. 6A-6B are diagrams illustrating examples 600 and 605 of DU migration in accordance with the present disclosure.

As shown in FIG. 6A, an IAB-MT may communicate with an IAB-donor-DU1. An IAB-DU1 may communicate with an IAB-donor-CU1 via the IAB-donor-DU1using an F1 link. Additionally, the IAB-DU1 may communicate with the UE.

In an example operation 610, the IAB-MT may perform a partial migration from the IAB-donor-CU1 to the IAB-donor-CU2. The IAB-MT may switch from communicating with the IAB-donor-DUI to communicating with the IAB-donor-DU2. The IAB-DU1 may communicate with the IAB-donor-CU1 via the IAB-donor-DU2 using the F1 link.

In an example operation 615, another F1 link may be established between IAB-DU2 and IAB-donor-CU2. The IAB-MT may continue to communicate with the IAB-donor-DU2. The IAB-DU1 may continue to communicate with the IAB-donor-CU1 via the IAB-donor-DU2 using the F1 link. Additionally, the IAB-DU2 may communicate with an IAB-donor-CU2 via the IAB-donor-DU2 using another F1 link.

In an example operation 620, a handover of connected UE(s) may occur between the IAB-donor-CU1 and the IAB-donor-CU2, and a cell-reselection may be performed by one or more idle UEs. The IAB-MT may continue to communicate with the IAB-donor-DU2. The IAB-DU1 may continue to communicate with the IAB-donor-CU1 via the IAB-donor-DU2 using the F1 link. The IAB-DU2 may continue to communicate with the IAB-donor-CU2 via the IAB-donor-DU2 using the other F1 link. The UE may switch from communicating with the IAB-DU1 to communicating with the IAB-DU2.

In an example operation 625, the F1 link between the IAB-DU1 and the IAB-donor-CU1 may be released. The IAB-MT may continue to communicate with the IAB-donor-DU2. Additionally, the IAB-DU2 may continue to communicate with the IAB-donor-CU2 via the IAB-donor-DU2 and using the other F1 link. The UE may continue to communicate with the IAB-DU2.

As shown in FIG. 6B, and by reference number 630, CU1 may transmit a trigger for an F1 setup to L-IAB-DU1. The trigger for the F1 setup may include an internet protocol (IP) address of CU2. In an example operation 635, L-IAB-DU2 may transmit an F1 setup request to CU2. The F1 setup request may include an identifier of CUx. In an example operation 640, CU2 may transmit an F1 setup response to L-IAB-DU2. In an example operation 645, L-IAB-DU1 may transmit a report to CU1. The report may indicate that the F1 setup was successful and that the cell identifiers have been activated by CU2.

In some cases, when triggering an F1 setup procedure on a mobile IAB-node (mIAB-node), the source logical mobile IAB-DU's (mIAB-DU's) CU may include the IP address of the target logical mIAB-DU's CU. In some cases, the target logical mIAB-DU may include the mobile IAB-MT's (mIAB-MT's) CU ID in the F1 setup request message. In some cases, the target logical mIAB-DU's CU may include the mIAB-node's backhaul adaptation protocol (BAP) address into the initial Xn IAB transport migration management request with the mIAB-MT's CU. In some cases, the IAB-node may transmit, via an F1 application protocol (F1-AP), to the source logical mIAB-DU's CU, an indication of the target logical mIAB-DU's successful F1 setup as well as the cell identifiers activated on the target logical mIAB-DU. In some cases, after all UEs have been handed over, the source logical mIAB-DU's F1-AP association can be released by the IAB-node or by the source logical mIAB-DU's CU.

In some cases (for example, in accordance with the RAN2 agreements), during a full migration, the UE may see the two logical DU cells as different physical cells (for example, with different PCIs, if using the same carrier), and the two logical DU cells may use separate physical resources (for example, different carriers, or orthogonal time and frequency resources of the same carrier, as supported by legacy L1).

In some cases (for example, in accordance with the RAN3 agreements), the mIAB-MT and its co-located mIAB-DU can be handed over or migrated to different donor CUs. In the case that the donor of the mIAB-DU decides the F1-AP setup for DU migration, the donor of the mIAB-DU may trigger, via F1 signaling, the IAB node to perform the F1 setup procedure for the DU migration. The trigger for F1 setup between the mobile IAB-node's second logical DU and its donor CU may be based on or otherwise associated with operations, administration, and maintenance (OAM) or on a configuration. In some cases, to avoid PCI collision, an F1-terminating IAB-donor can reconfigure the PCI for the cell of the mobile IAB-DU via an existing F1-AP message.

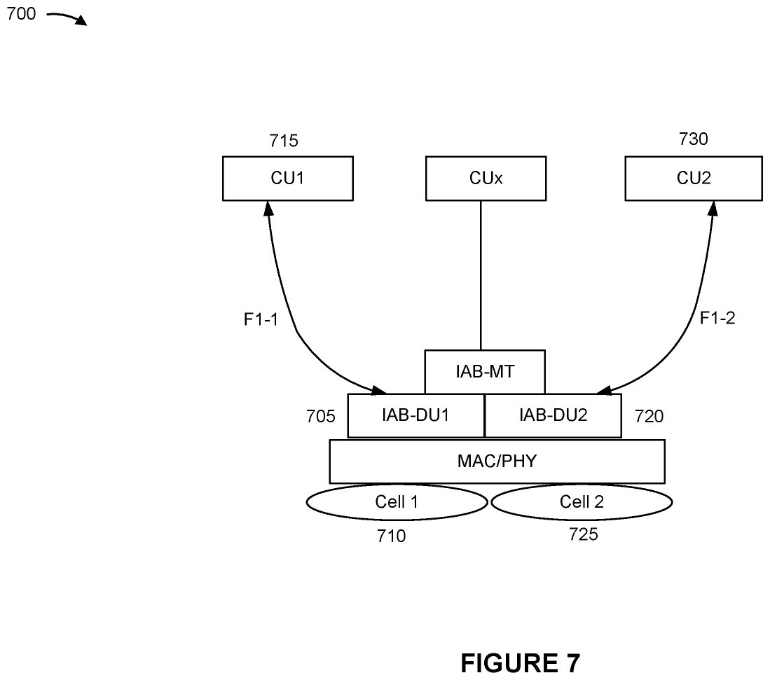

FIG. 7 is a diagram illustrating an example 700 of a PCI value for a cell connected to an IAB-node in accordance with the present disclosure.

In some cases, an IAB-node may establish one or more F1 connections with one or more donor-CUs, respectively, where each donor-CU instantiates a logical IAB-DU on the IAB-node. For each F1 connection, the respective IAB-DU may report a list of served cells to the corresponding donor-CU. For example, IAB-DU1 705 may report cell1 710 to CU1 715, and IAB-DU2 720 may report cell2 725 to CU2 730. In some cases, such as in accordance with the RAN2 agreements, cell1 710 and cell2 725 may use different PCIs if cell1 710 and cell2 725 are associated with the same carrier. In some cases, such as in accordance with the RAN3 agreements, the PCI of an IAB-DU cell may be configured (for example, reconfigured) by an F1-terminating CU. For example, the PCI of cell1 710 may be reconfigured by CU1 715 and the PCI of cell2 725 may be reconfigured by CU2 730. If cell1 710 and cell2 725 use the same carrier, one CU may reconfigure the PCI of its associated cell to the same PCI value of the other cell. However, this may violate the RAN2 agreement. Additionally, this may result in increased interference, an increased likelihood of PCI collision for connected UEs, and/or an increased likelihood of UE handover failure during a full migration between cells.

Various aspects generally relate to PCI management. Some aspects more specifically relate to an indication of restricted PCI value(s) or allowed PCI value(s) that can be reported to a CU to be used for a PCI configuration of a cell. The PCI configuration may be indicated per F1 connection. In some aspects, a DU associated with an IAB-node may transmit, and a CU may receive, a restriction indication that indicates a restriction for a PCI configuration of a cell that is served by the DU. The restriction indication may include, for example, one or more PCI values that are not to be used for the PCI configuration of the cell, and/or may include one or more PCI values that are allowed to be used for the PCI configuration of the cell. The CU may transmit, and the DU may receive, a PCI configuration of the cell that is based on or otherwise associated with the restriction indication. For example, the PCI configuration may not include a PCI value that is included in the one or more PCI values that are not to be used for the PCI configuration of the cell, and/or may include a PCI value that is included in the one or more PCI values that are allowed to be used for the PCI configuration of the cell.

Particular aspects of the subject matter described in this disclosure can be implemented to realize one or more of the following potential advantages. In some examples, the described techniques can be used to reduce interference, reduce a likelihood of PCI collision for connected UEs, and/or reduce a likelihood of UE handover failure during a full migration between cells.

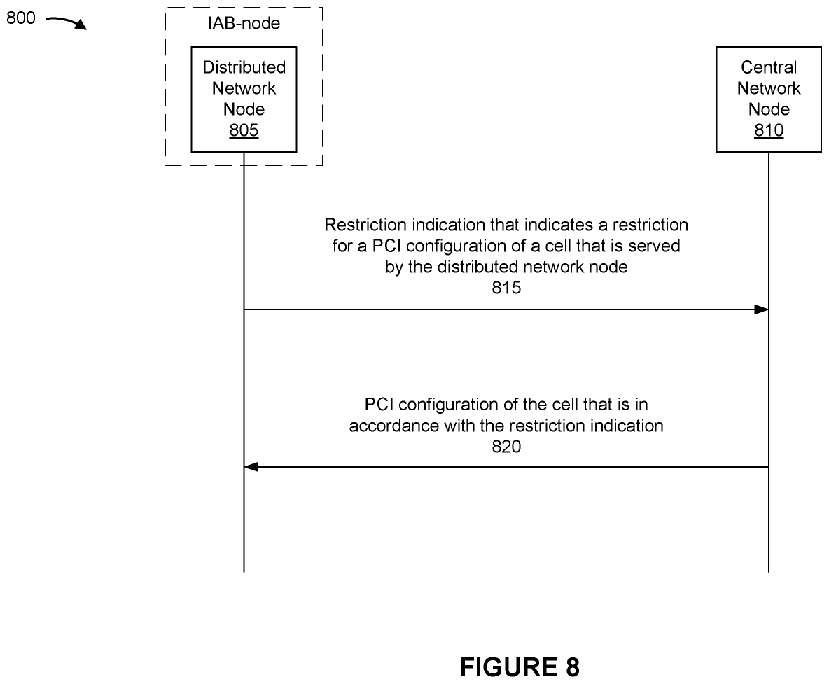

FIG. 8 is a diagram illustrating an example 800 of PCI management in accordance with the present disclosure. A distributed network node 805 may communicate with a central network node 810. The distributed network node 805 may be associated with an IAB-node. In some aspects, the distributed network node 805 may be a DU and the central network node 810 may be a CU.

In an example operation 815, the distributed network node 805 may transmit, and the central network node 810 may receive, a restriction indication that indicates a restriction for a PCI configuration of a cell that is served by the distributed network node 805.

In an example operation 820, the central network node 810 may transmit, and the distributed network node 805 may receive, a PCI configuration of the cell that is based on or otherwise associated with the restriction indication.

In some aspects, the restriction indication may include a PCI value that is not to be used for the PCI configuration of the cell. In this example, receiving the PCI configuration of the cell may include receiving a PCI configuration having a PCI value that does not correspond to the PCI value indicated in the restriction indication. In some other aspects, the restriction indication may include a plurality of PCI values that are not to be used for the PCI configuration of the cell. In this example, receiving the PCI configuration of the cell may include receiving a PCI configuration having a PCI value that does not correspond to any of the PCI values indicated in the restriction indication. In some other aspects, the restriction indication may include a plurality of PCI values that are allowed to be used for the PCI configuration of the cell. In this example, receiving the PCI configuration of the cell may include receiving a PCI configuration having a PCI value that corresponds to one of the plurality of PCI values indicated in the restriction indication.

In some aspects, the cell may be indicated by the distributed network node 805 using a cell identifier (cell ID). In some aspects, the cell ID may be a PCI value that is based on or otherwise associated with the restriction indication. In some aspects, receiving the PCI configuration of the cell may include receiving a PCI configuration of the cell that includes another PCI value that is equal to the PCI value of the cell ID. In some other aspects, receiving the PCI configuration of the cell may include receiving a PCI configuration of the cell that includes another PCI value that is different than the PCI value of the cell ID. In some aspects, the cell ID may be a cell global identity (CGI).

In some aspects, transmitting the restriction indication to the central network node 810 may include transmitting the restriction indication to the central network node 810 based on or otherwise associated with transmitting an indication of a restricted PCI value to another cell. In some aspects, the cell may be associated with a first frequency carrier and the other cell may be associated with a second frequency carrier, where the first frequency carrier at least partially overlaps with the second frequency carrier, and where transmitting the restriction indication comprises transmitting the restriction indication based on or otherwise associated with the first frequency carrier overlapping with the second frequency carrier. In some other aspects, the other cell may be associated with another central network node, where transmitting the restriction indication comprises transmitting the restriction indication based on or otherwise associated with transmitting an indication of the other cell to the other central network node. In some other aspects, the other cell may be associated with another central network node, where transmitting the restriction indication comprises transmitting the restriction indication based on or otherwise associated with an indication that the other central network node has activated the other cell.

In some aspects, the distributed network node 805 may transmit, and the central network node 810 may receive, a first synchronization signal block (SSB) that is based on or otherwise associated with the PCI configuration and a second SSB that is based on or otherwise associated with a restricted PCI value. The first SSB and the second SSB may be transmitted on a shared frequency resource.

In some aspects, the distributed network node 805 may transmit, and the central network node 810 may receive, another restriction indication that includes an updated restriction for the PCI configuration of the cell. In some aspects, transmitting the other restriction indication may include transmitting the other restriction indication based on or otherwise associated with the distributed network node 805 adding or deleting another cell having a PCI value associated with the updated restriction. In some other aspects, transmitting the other restriction indication may include transmitting the other restriction indication based on or otherwise associated with the distributed network node 805 activating or deactivating another cell having a PCI value associated with the updated restriction. In some other aspects, transmitting the other restriction indication may include transmitting the other restriction indication based on or otherwise associated with the distributed network node 805 reconfiguring a PCI value for another cell that is served by the distributed network node 805.

In some aspects, transmitting the restriction indication that indicates the restriction for the PCI configuration of the cell may include transmitting a restriction indication that indicates a restriction for a PCI configuration of a frequency resource, where the cell is associated with the frequency resource. In some aspects, transmitting the restriction indication may include transmitting the restriction indication based on or otherwise associated with receiving another PCI configuration of the cell, and based on or otherwise associated with the distributed network node 805 rejecting the other PCI configuration or indicating a failure to apply the other PCI configuration.

As described herein, the PCI configuration may be used to enhance the F1 interface. In some aspects, the PCI configuration for the cell may be transmitted by a DU that is part of an IAB node and may be received by a CU that is part of an IAB donor. In some other aspects, the PCI configuration for the cell may be transmitted by a DU that is not part of an IAB node and may be received by a CU that is not part of an IAB donor. Thus, the PCI configuration may generalize to networks other than IAB.

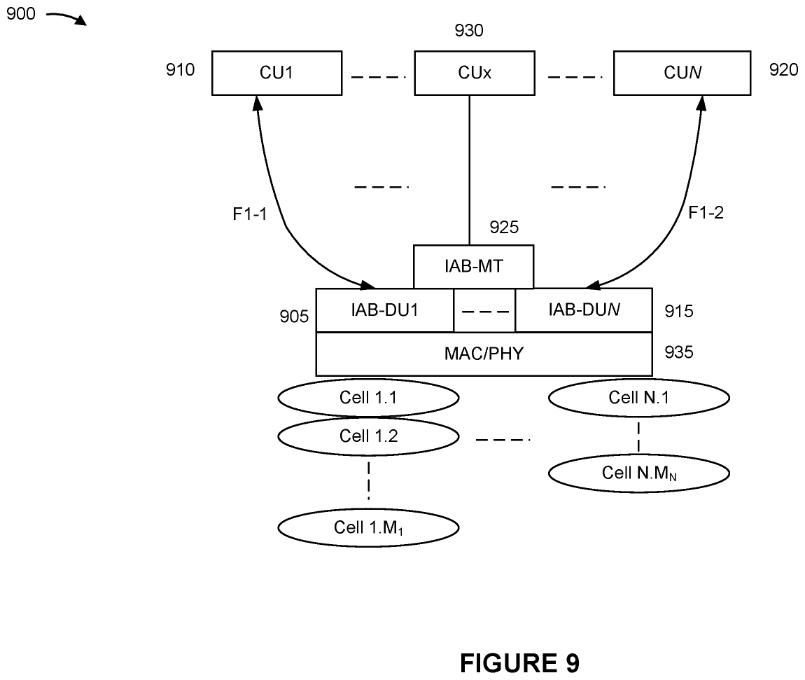

FIG. 9 is a diagram illustrating an example 900 of PCI values for a plurality of cells connected to an IAB-node in accordance with the present disclosure. In some aspects, an IAB-node may have N F1 connections to N IAB-CUs corresponding to N logical IAB-DUs. For example, IAB-DU1 905 may have an F1 connection (F1-1) to CU1 910, and IAB-DUN 915 may have another F1 connection (F1-2) to CUN 920. The N F1 connections may be transported via the IAB-MT 925 Uu connection(s) that terminate at one or more CUx(s) 930. In some aspects, any of the IAB-DU's CUs could be the same as the IAB-MT's CU(s). While the IAB-DUs are logical, the IAB-DUs may run on top of a MAC/PHY 935 of the IAB-node, which serves a set of physical cells. For example, cells 1.1 to 1.M1 may be associated with IAB-DU1 and IAB-CU1, and cells 2.1 to 2.M2 may be associated with IAB-DU2 and IAB-CU2, among other examples. In some aspects, the total number of physical cells served by the IAB-node may be M1+M2 . . . +MN. Each physical cell may be identified by a cell ID, such as a PCI or an NR cell global identifier (NCGI). The NCGI may include a network node ID (for example, gNB-ID) that corresponds to the respective CU. In some aspects, the PCI may be reconfigurable. In some aspects, a cell associated with an IAB-DU/IAB-CU may be activated by the IAB-CU. In some aspects, the cells may be located on the same carriers. In some other aspects, the cells may be located on different carriers.

FIG. 10 is a flowchart illustrating an example process 1000 performed, for example, by a distributed network node that supports PCI management in accordance with the present disclosure. Example process 1000 is an example where the distributed network node (for example, distributed network node 110) performs operations associated with physical cell identifier management.

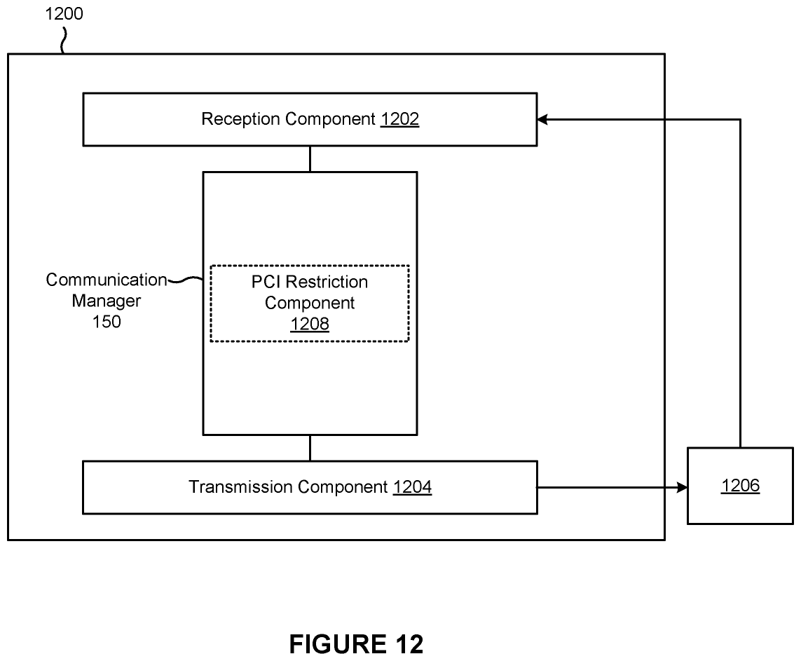

As shown in FIG. 10, in some aspects, process 1000 may include transmitting, to a central network node, a restriction indication that indicates a restriction for a PCI configuration of a cell that is served by the distributed network node, the distributed network node being associated with an integrated access and backhaul node (block 1010). For example, the distributed network node (such as by using communication manager 150 or transmission component 1204, depicted in FIG. 12) may transmit, to a central network node, a restriction indication that indicates a restriction for a PCI configuration of a cell that is served by the distributed network node, the distributed network node being associated with an integrated access and backhaul node, as described above.

As further shown in FIG. 10, in some aspects, process 1000 may include receiving, from the central network node, a PCI configuration of the cell that is based on or otherwise associated with the restriction indication (block 1020). For example, the distributed network node (such as by using communication manager 150 or reception component 1202, depicted in FIG. 12) may receive, from the central network node, a PCI configuration of the cell that is based on or otherwise associated with the restriction indication, as described above.

Process 1000 may include additional aspects, such as any single aspect or any combination of aspects described below or in connection with one or more other processes described elsewhere herein.

In a first additional aspect, the restriction indication includes a PCI value that is not to be used for the PCI configuration of the cell.

In a second additional aspect, alone or in combination with the first aspect, the restriction indication includes a plurality of PCI values that are not to be used for the PCI configuration of the cell.

In a third additional aspect, alone or in combination with one or more of the first and second aspects, the restriction indication includes a plurality of PCI values that are allowed to be used for the PCI configuration of the cell, and wherein receiving the PCI configuration of the cell comprises receiving a PCI configuration of the cell that is based on or otherwise associated with a PCI value of the plurality PCI values that are allowed to be used for the PCI configuration of the cell.

In a fourth additional aspect, alone or in combination with one or more of the first through third aspects, the cell is indicated using a cell identifier.

In a fifth additional aspect, alone or in combination with one or more of the first through fourth aspects, the cell identifier is a PCI value that is based on or otherwise associated with the restriction indication.

In a sixth additional aspect, alone or in combination with one or more of the first through fifth aspects, receiving the PCI configuration of the cell comprises receiving a PCI configuration of the cell that includes another PCI value that is equal to the PCI value.

In a seventh additional aspect, alone or in combination with one or more of the first through sixth aspects, receiving the PCI configuration of the cell comprises receiving a PCI configuration of the cell that includes another PCI value that is different than the PCI value.

In an eighth additional aspect, alone or in combination with one or more of the first through seventh aspects, the cell identifier is a cell global identity.

In a ninth additional aspect, alone or in combination with one or more of the first through eighth aspects, transmitting the restriction indication to the central network node comprises transmitting the restriction indication to the central network node based on or otherwise associated with transmitting an indication of a restricted PCI value to another cell.

In a tenth additional aspect, alone or in combination with one or more of the first through ninth aspects, the cell is associated with a first frequency carrier and the other cell is associated with a second frequency carrier, wherein the first frequency carrier at least partially overlaps with the second frequency carrier, and wherein transmitting the restriction indication comprises transmitting the restriction indication based on or otherwise associated with the first frequency carrier overlapping with the second frequency carrier.

In an eleventh additional aspect, alone or in combination with one or more of the first through tenth aspects, the other cell is associated with another central network node, wherein transmitting the restriction indication comprises transmitting the restriction indication based on or otherwise associated with transmitting an indication of the other cell to the other central network node.

In a twelfth additional aspect, alone or in combination with one or more of the first through eleventh aspects, the other cell is associated with another central network node, wherein transmitting the restriction indication comprises transmitting the restriction indication based on or otherwise associated with an indication that the other central network node has activated the other cell.

In a thirteenth additional aspect, alone or in combination with one or more of the first through twelfth aspects, process 1000 includes transmitting, on a shared frequency resource, a first a SSB that is based on or otherwise associated with the PCI configuration and a second SSB that is based on or otherwise associated with a restricted PCI value.

In a fourteenth additional aspect, alone or in combination with one or more of the first through thirteenth aspects, process 1000 includes transmitting, to the central network node, another restriction indication that includes an updated restriction for the PCI configuration of the cell.

In a fifteenth additional aspect, alone or in combination with one or more of the first through fourteenth aspects, transmitting the other restriction indication comprises transmitting the other restriction indication based on or otherwise associated with the distributed network node adding or deleting another cell having a PCI value associated with the updated restriction.

In a sixteenth additional aspect, alone or in combination with one or more of the first through fifteenth aspects, transmitting the other restriction indication comprises transmitting the other restriction indication based on or otherwise associated with the distributed network node activating or deactivating another cell having a PCI value associated with the updated restriction.

In a seventeenth additional aspect, alone or in combination with one or more of the first through sixteenth aspects, transmitting the other restriction indication comprises transmitting the other restriction indication based on or otherwise associated with the distributed network node reconfiguring a PCI value for another cell that is served by the distributed network node.

In an eighteenth additional aspect, alone or in combination with one or more of the first through seventeenth aspects, transmitting the restriction indication that indicates the restriction for the PCI configuration of the cell comprises transmitting a restriction indication that indicates a restriction for a PCI configuration of a frequency resource, wherein the cell is associated with the frequency resource.

In a nineteenth additional aspect, alone or in combination with one or more of the first through eighteenth aspects, transmitting the restriction indication comprises transmitting the restriction indication based on or otherwise associated with receiving another PCI configuration of the cell, and based on or otherwise associated with rejecting the other PCI configuration or indicating a failure to apply the other PCI configuration.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a flowchart illustrating an example process 1100 performed, for example, by a central network node that supports PCI management in accordance with the present disclosure. Example process 1100 is an example where the central network node (for example, central network node 110) performs operations associated with physical cell identifier management.

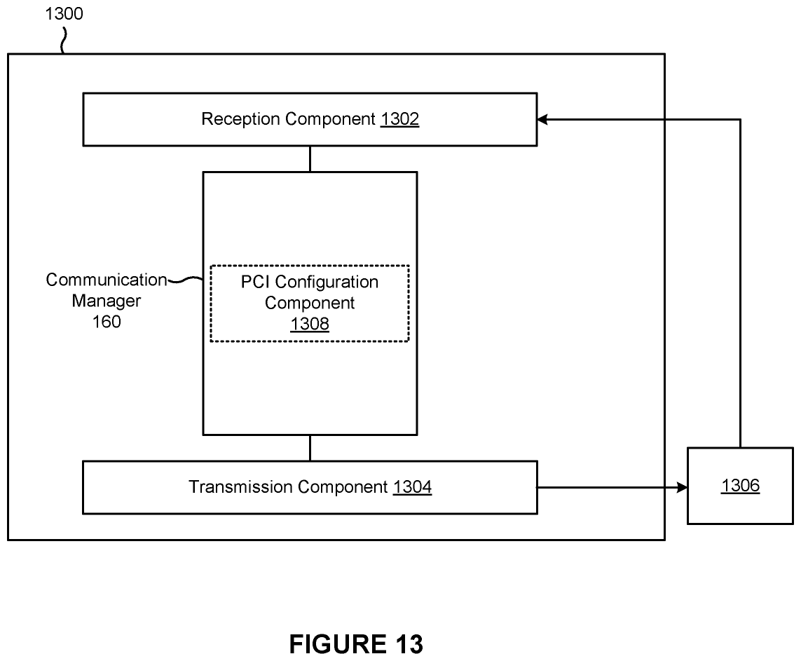

As shown in FIG. 11, in some aspects, process 1100 may include receiving, from a distributed network node associated with an integrated access and backhaul node, a restriction indication that indicates a restriction for a PCI configuration of a cell that is served by the distributed network node (block 1110). For example, the central network node (such as by using communication manager 160 or reception component 1302, depicted in FIG. 13) may receive, from a distributed network node associated with an integrated access and backhaul node, a restriction indication that indicates a restriction for a PCI configuration of a cell that is served by the distributed network node, as described above.

As further shown in FIG. 11, in some aspects, process 1100 may include transmitting, to the distributed network node, a PCI configuration of the cell that is based on or otherwise associated with the restriction indication (block 1120). For example, the central network node (such as by using communication manager 160 or transmission component 1304, depicted in FIG. 13) may transmit, to the distributed network node, a PCI configuration of the cell that is based on or otherwise associated with the restriction indication, as described above.

Process 1100 may include additional aspects, such as any single aspect or any combination of aspects described below or in connection with one or more other processes described elsewhere herein.

In a first additional aspect, the restriction indication includes a PCI value that is not to be used for the PCI configuration of the cell.

In a second additional aspect, alone or in combination with the first aspect, the restriction indication includes a plurality of PCI values that are not to be used for the PCI configuration of the cell.

In a third additional aspect, alone or in combination with one or more of the first and second aspects, the restriction indication includes a plurality of PCI values that are allowed to be used for the PCI configuration of the cell, and wherein transmitting the PCI configuration of the cell comprises transmitting a PCI configuration of the cell that is based on or otherwise associated with a PCI value of the plurality PCI values that are allowed to be used for the PCI configuration of the cell.

In a fourth additional aspect, alone or in combination with one or more of the first through third aspects, the cell is indicated using a cell identifier.

In a fifth additional aspect, alone or in combination with one or more of the first through fourth aspects, the cell identifier is a PCI value that is based on or otherwise associated with the restriction indication.

In a sixth additional aspect, alone or in combination with one or more of the first through fifth aspects, transmitting the PCI configuration of the cell comprises transmitting a PCI configuration of the cell that includes another PCI value that is equal to the PCI value.

In a seventh additional aspect, alone or in combination with one or more of the first through sixth aspects, transmitting the PCI configuration of the cell comprises transmitting a PCI configuration of the cell that includes another PCI value that is different than the PCI value.

In an eighth additional aspect, alone or in combination with one or more of the first through seventh aspects, the cell identifier is a cell global identity.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a diagram of an example apparatus 1200 for wireless communication that supports PCI management in accordance with the present disclosure. The apparatus 1200 may be a distributed network node, or a distributed network node may include the apparatus 1200. In some aspects, the apparatus 1200 includes a reception component 1202, a transmission component 1204, and a communication manager 150, which may be in communication with one another (for example, via one or more buses). As shown, the apparatus 1200 may communicate with another apparatus 1206 (such as a UE, a network node, or another wireless communication device) using the reception component 1202 and the transmission component 1204.

In some aspects, the apparatus 1200 may be configured to and/or operable to perform one or more operations described herein in connection with FIGS. 8-9. Additionally or alternatively, the apparatus 1200 may be configured to and/or operable to perform one or more processes described herein, such as process 1000 of FIG. 10. In some aspects, the apparatus 1200 may include one or more components of the distributed network node described above in connection with FIG. 2.

The reception component 1202 may receive communications, such as reference signals, control information, and/or data communications, from the apparatus 1206. The reception component 1202 may provide received communications to one or more other components of the apparatus 1200, such as the communication manager 150. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, a modem, a demodulator, a MIMO detector, a receive processor, a controller/processor, and/or a memory of the distributed network node described above in connection with FIG. 2.

The transmission component 1204 may transmit communications, such as reference signals, control information, and/or data communications, to the apparatus 1206. In some aspects, the communication manager 150 may generate communications and may transmit the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, and/or a memory of the distributed network node described above in connection with FIG. 2. In some aspects, the transmission component 1204 may be co-located with the reception component 1202 in a transceiver.

The communication manager 150 may transmit or may cause the transmission component 1204 to transmit, to a central network node, a restriction indication that indicates a restriction for a PCI configuration of a cell that is served by the distributed network node, the distributed network node being associated with an integrated access and backhaul node. The communication manager 150 may receive or may cause the reception component 1202 to receive, from the central network node, a PCI configuration of the cell that is based on or otherwise associated with the restriction indication. In some aspects, the communication manager 150 may perform one or more operations described elsewhere herein as being performed by one or more components of the communication manager 150.

The communication manager 150 may include a controller/processor, a memory, a scheduler, and/or a communication unit of the distributed network node described above in connection with FIG. 2. In some aspects, the communication manager 150 includes a set of components, such as a PCI restriction component 1208. Alternatively, the set of components may be separate and distinct from the communication manager 150. In some aspects, one or more components of the set of components may include or may be implemented within a controller/processor, a memory, a scheduler, and/or a communication unit of the distributed network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The PCI restriction component 1208 may determine a restriction indication for a PCI configuration of a cell that is served by the distributed network node. The transmission component 1204 may transmit, to a central network node, the restriction indication that indicates the restriction for a PCI configuration of the cell that is served by the distributed network node, the distributed network node being associated with an integrated access and backhaul node. The reception component 1202 may receive, from the central network node, a PCI configuration of the cell that is based on or otherwise associated with the restriction indication. The transmission component 1204 may transmit, on a shared frequency resource, a first a SSB that is based on or otherwise associated with the PCI configuration and a second SSB that is based on or otherwise associated with a restricted PCI value.

The transmission component 1204 may transmit, to the central network node, another restriction indication that includes an updated restriction for the PCI configuration of the cell. The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

FIG. 13 is a diagram of an example apparatus 1300 for wireless communication that supports PCI management in accordance with the present disclosure. The apparatus 1300 may be a central network node, or a central network node may include the apparatus 1300. In some aspects, the apparatus 1300 includes a reception component 1302, a transmission component 1304, and a communication manager 160, which may be in communication with one another (for example, via one or more buses). As shown, the apparatus 1300 may communicate with another apparatus 1306 (such as a UE, a network node, or another wireless communication device) using the reception component 1302 and the transmission component 1304.

In some aspects, the apparatus 1300 may be configured to and/or operable to perform one or more operations described herein in connection with FIGS. 8-9. Additionally or alternatively, the apparatus 1300 may be configured to and/or operable to perform one or more processes described herein, such as process 1100 of FIG. 11. In some aspects, the apparatus 1300 may include one or more components of the central network node described above in connection with FIG. 2.

The reception component 1302 may receive communications, such as reference signals, control information, and/or data communications, from the apparatus 1306. The reception component 1302 may provide received communications to one or more other components of the apparatus 1300, such as the communication manager 160. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1302 may include one or more antennas, a modem, a demodulator, a MIMO detector, a receive processor, a controller/processor, and/or a memory of the central network node described above in connection with FIG. 2.

The transmission component 1304 may transmit communications, such as reference signals, control information, and/or data communications, to the apparatus 1306. In some aspects, the communication manager 160 may generate communications and may transmit the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, and/or a memory of the central network node described above in connection with FIG. 2. In some aspects, the transmission component 1304 may be co-located with the reception component 1302 in a transceiver.

The communication manager 160 may receive or may cause the reception component 1302 to receive, from a distributed network node associated with an integrated access and backhaul node, a restriction indication that indicates a restriction for a PCI configuration of a cell that is served by the distributed network node. The communication manager 160 may transmit or may cause the transmission component 1304 to transmit, to the distributed network node, a PCI configuration of the cell that is based on or otherwise associated with the restriction indication. In some aspects, the communication manager 160 may perform one or more operations described elsewhere herein as being performed by one or more components of the communication manager 160.

The communication manager 160 may include a controller/processor, a memory, a scheduler, and/or a communication unit of the central network node described above in connection with FIG. 2. In some aspects, the communication manager 160 includes a set of components, such as a PCI configuration component 1308. Alternatively, the set of components may be separate and distinct from the communication manager 160. In some aspects, one or more components of the set of components may include or may be implemented within a controller/processor, a memory, a scheduler, and/or a communication unit of the central network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive, from a distributed network node associated with an integrated access and backhaul node, a restriction indication that indicates a restriction for a PCI configuration of a cell that is served by the distributed network node. The PCI configuration component 1308 may determine a PCI configuration of the cell that is based on or otherwise associated with the restriction indication. The transmission component 1304 may transmit, to the distributed network node, the PCI configuration of the cell that is based on or otherwise associated with the restriction indication.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

The following provides an overview of some Aspects of the present disclosure:

Aspect 1: A method for wireless communication by a distributed network node, comprising: transmitting, to a central network node, a restriction indication that indicates a restriction for a physical cell identifier (PCI) configuration of a cell that is served by the distributed network node, the distributed network node being associated with an integrated access and backhaul node; and receiving, from the central network node, a PCI configuration of the cell that is in accordance with the restriction indication.

Aspect 2: The method of Aspect 1, wherein the restriction indication includes a PCI value that is not to be used for the PCI configuration of the cell.

Aspect 3: The method of any of Aspects 1-2, wherein the restriction indication includes a plurality of PCI values that are not to be used for the PCI configuration of the cell.

Aspect 4: The method of any of Aspects 1-3, wherein the restriction indication includes a plurality of PCI values that are allowed to be used for the PCI configuration of the cell, and wherein receiving the PCI configuration of the cell comprises receiving a PCI configuration of the cell that is in accordance with a PCI value of the plurality PCI values that are allowed to be used for the PCI configuration of the cell.

Aspect 5: The method of any of Aspects 1-4, wherein the cell is indicated using a cell identifier.

Aspect 6: The method of Aspect 5, wherein the cell identifier is a PCI value that is in accordance with the restriction indication.

Aspect 7: The method of Aspect 6, wherein receiving the PCI configuration of the cell comprises receiving a PCI configuration of the cell that includes another PCI value that is equal to the PCI value.

Aspect 8: The method of Aspect 6, wherein receiving the PCI configuration of the cell comprises receiving a PCI configuration of the cell that includes another PCI value that is different than the PCI value.

Aspect 9: The method of Aspect 5, wherein the cell identifier is a cell global identity.

Aspect 10: The method of any of Aspects 1-9, wherein transmitting the restriction indication to the central network node comprises transmitting the restriction indication to the central network node in accordance with transmitting an indication of a restricted PCI value to another cell.

Aspect 11: The method of Aspect 10, wherein the cell is associated with a first frequency carrier and the other cell is associated with a second frequency carrier, wherein the first frequency carrier at least partially overlaps with the second frequency carrier, and wherein transmitting the restriction indication comprises transmitting the restriction indication in accordance with the first frequency carrier overlapping with the second frequency carrier.

Aspect 12: The method of Aspect 10, wherein the other cell is associated with another central network node, wherein transmitting the restriction indication comprises transmitting the restriction indication in accordance with transmitting an indication of the other cell to the other central network node.

Aspect 13: The method of Aspect 10, wherein the other cell is associated with another central network node, wherein transmitting the restriction indication comprises transmitting the restriction indication in accordance with an indication that the other central network node has activated the other cell.

Aspect 14: The method of any of Aspects 1-13, further comprising transmitting, on a shared frequency resource, a first a synchronization signal block (SSB) that is in accordance with the PCI configuration and a second SSB that is in accordance with a restricted PCI value.

Aspect 15: The method of any of Aspects 1-14, further comprising transmitting, to the central network node, another restriction indication that includes an updated restriction for the PCI configuration of the cell.

Aspect 16: The method of Aspect 15, wherein transmitting the other restriction indication comprises transmitting the other restriction indication in accordance with the distributed network node adding or deleting another cell having a PCI value associated with the updated restriction.

Aspect 17: The method of Aspect 15, wherein transmitting the other restriction indication comprises transmitting the other restriction indication in accordance with the distributed network node activating or deactivating another cell having a PCI value associated with the updated restriction.

Aspect 18: The method of Aspect 15 wherein transmitting the other restriction indication comprises transmitting the other restriction indication in accordance with the distributed network node reconfiguring a PCI value for another cell that is served by the distributed network node.

Aspect 19: The method of any of Aspects 1-18, wherein transmitting the restriction indication that indicates the restriction for the PCI configuration of the cell comprises transmitting a restriction indication that indicates a restriction for a PCI configuration of a frequency resource, wherein the cell is associated with the frequency resource.

Aspect 20: The method of any of Aspects 1-19, wherein transmitting the restriction indication comprises transmitting the restriction indication in accordance with receiving another PCI configuration of the cell, and in accordance with rejecting the other PCI configuration or indicating a failure to apply the other PCI configuration.

Aspect 21: A method for wireless communication by a central network node, comprising: receiving, from a distributed network node associated with an integrated access and backhaul node, a restriction indication that indicates a restriction for a physical cell identifier (PCI) configuration of a cell that is served by the distributed network node; and transmitting, to the distributed network node, a PCI configuration of the cell that is in accordance with the restriction indication.

Aspect 22: The method of Aspect 21, wherein the restriction indication includes a PCI value that is not to be used for the PCI configuration of the cell.

Aspect 23: The method of any of Aspects 21-22, wherein the restriction indication includes a plurality of PCI values that are not to be used for the PCI configuration of the cell.

Aspect 24: The method of any of Aspects 21-23, wherein the restriction indication includes a plurality of PCI values that are allowed to be used for the PCI configuration of the cell, and wherein transmitting the PCI configuration of the cell comprises transmitting a PCI configuration of the cell that is in accordance with a PCI value of the plurality PCI values that are allowed to be used for the PCI configuration of the cell.

Aspect 25: The method of any of Aspects 21-24, wherein the cell is indicated using a cell identifier.

Aspect 26: The method of Aspect 25, wherein the cell identifier is a PCI value that is in accordance with the restriction indication.

Aspect 27: The method of Aspect 26, wherein transmitting the PCI configuration of the cell comprises transmitting a PCI configuration of the cell that includes another PCI value that is equal to the PCI value.

Aspect 28: The method of Aspect 26, wherein transmitting the PCI configuration of the cell comprises transmitting a PCI configuration of the cell that includes another PCI value that is different than the PCI value.

Aspect 29: The method of Aspect 25, wherein the cell identifier is a cell global identity.

Aspect 30: An apparatus for wireless communication at a device, comprising a processor; memory coupled with the processor; and instructions stored in the memory and executable by the processor to cause the apparatus to perform the method of one or more of Aspects 1-29.

Aspect 31: A device for wireless communication, comprising a memory and one or more processors coupled to the memory, the one or more processors configured to perform the method of one or more of Aspects 1-29.

Aspect 32: An apparatus for wireless communication, comprising at least one means for performing the method of one or more of Aspects 1-29.

Aspect 33: A non-transitory computer-readable medium storing code for wireless communication, the code comprising instructions executable by a processor to perform the method of one or more of Aspects 1-29.

Aspect 34: A non-transitory computer-readable medium storing a set of instructions for wireless communication, the set of instructions comprising one or more instructions that, when executed by one or more processors of a device, cause the device to perform the method of one or more of Aspects 1-29.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No clement, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an clement “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “cither” or “only one of”).

What is claimed is:

1. A distributed network node for wireless communication, comprising:
a processing system that includes one or more processors and one or more memories coupled with the one or more processors, the processing system configured to cause the distributed network node to:
transmit, to a central network node, a restriction indication that indicates a restriction for a physical cell identifier (PCI) configuration of a cell that is served by the distributed network node, the distributed network node being associated with an integrated access and backhaul node; and
receive, from the central network node, a PCI configuration of the cell that is in accordance with the restriction indication.

2. The distributed network node of claim 1, wherein the restriction indication includes a PCI value that is not to be used for the PCI configuration of the cell.

3. The distributed network node of claim 1, wherein the restriction indication includes a plurality of PCI values that are not to be used for the PCI configuration of the cell.

4. The distributed network node of claim 1, wherein the restriction indication includes a plurality of PCI values that are allowed to be used for the PCI configuration of the cell, and wherein, to cause the distributed network node to receive the PCI configuration of the cell, the processing system is configured to cause the distributed network node to receive a PCI configuration of the cell that is in accordance with a PCI value of the plurality PCI values that are allowed to be used for the PCI configuration of the cell.

5. The distributed network node of claim 1, wherein the cell is indicated using a cell identifier.

6. The distributed network node of claim 5, wherein the cell identifier is a PCI value that is in accordance with the restriction indication.

7. The distributed network node of claim 6, wherein, to cause the distributed network node to receive the PCI configuration of the cell, the processing system is configured to cause the distributed network node to receive a PCI configuration of the cell that includes another PCI value that is equal to the PCI value.

8. The distributed network node of claim 6, wherein, to cause the distributed network node to receive the PCI configuration of the cell, the processing system is configured to cause the distributed network node to receive a PCI configuration of the cell that includes another PCI value that is different than the PCI value.

9. The distributed network node of claim 5, wherein the cell identifier is a cell global identity.

10. The distributed network node of claim 1, wherein, to cause the distributed network node to transmit the restriction indication to the central network node, the processing system is configured to cause the distributed network node to transmit the restriction indication to the central network node in accordance with transmitting an indication of a restricted PCI value to another cell.

11. The distributed network node of claim 10, wherein the cell is associated with a first frequency carrier and the other cell is associated with a second frequency carrier, wherein the first frequency carrier at least partially overlaps with the second frequency carrier, and wherein, to cause the distributed network node to transmit the restriction indication to the central network node, the processing system is configured to cause the distributed network node to transmit the restriction indication in accordance with the first frequency carrier overlapping with the second frequency carrier.

12. The distributed network node of claim 10, wherein the other cell is associated with another central network node, wherein, to cause the distributed network node to transmit the restriction indication to the central network node, the processing system is configured to cause the distributed network node to transmit the restriction indication in accordance with transmitting an indication of the other cell to the other central network node.

13. The distributed network node of claim 10, wherein the other cell is associated with another central network node, wherein, to cause the distributed network node to transmit the restriction indication to the central network node, the processing system is configured to cause the distributed network node to transmit the restriction indication in accordance with an indication that the other central network node has activated the other cell.

14. The distributed network node of claim 1, wherein the processing system is further configured to cause the distributed network node to transmit, on a shared frequency resource, a first a synchronization signal block (SSB) that is in accordance with the PCI configuration and a second SSB that is in accordance with a restricted PCI value.

15. The distributed network node of claim 1, wherein the processing system is further configured to cause the distributed network node to transmit, to the central network node, another restriction indication that includes an updated restriction for the PCI configuration of the cell.

16. The distributed network node of claim 15, wherein, to cause the distributed network node to transmit the other restriction indication, the processing system is configured to cause the distributed network node to transmit the other restriction indication in accordance with the distributed network node adding or deleting another cell having a PCI value associated with the updated restriction.

17. The distributed network node of claim 15, wherein, to cause the distributed network node to transmit the other restriction indication, the processing system is configured to cause the distributed network node to transmit the other restriction indication in accordance with the distributed network node activating or deactivating another cell having a PCI value associated with the updated restriction.

18. The distributed network node of claim 15, wherein, to cause the distributed network node to transmit the other restriction indication, the processing system is configured to cause the distributed network node to transmit the other restriction indication in accordance with the distributed network node reconfiguring a PCI value for another cell that is served by the distributed network node.

19. The distributed network node of claim 1, wherein, to cause the distributed network node to transmit the restriction indication that indicates the restriction for the PCI configuration of the cell, the processing system is configured to cause the distributed network node to transmit a restriction indication that indicates a restriction for a PCI configuration of a frequency resource, wherein the cell is associated with the frequency resource.

20. The distributed network node of claim 1, wherein, to cause the distributed network node to transmit the restriction indication, the processing system is configured to cause the distributed network node to transmit the restriction indication in accordance with receiving another PCI configuration of the cell, and in accordance with rejecting the other PCI configuration or indicating a failure to apply the other PCI configuration.

21. A central network node for wireless communication, comprising:
a processing system that includes one or more processors and one or more memories coupled with the one or more processors, the processing system configured to cause the central network node to:
receive, from a distributed network node associated with an integrated access and backhaul node, a restriction indication that indicates a restriction for a physical cell identifier (PCI) configuration of a cell that is served by the distributed network node; and
transmit, to the distributed network node, a PCI configuration of the cell that is in accordance with the restriction indication.

22. The central network node of claim 21, wherein the restriction indication includes a PCI value that is not to be used for the PCI configuration of the cell.

23. The central network node of claim 21, wherein the restriction indication includes a plurality of PCI values that are not to be used for the PCI configuration of the cell.

24. The central network node of claim 21, wherein the restriction indication includes a plurality of PCI values that are allowed to be used for the PCI configuration of the cell, and wherein, to cause the central network node to transmit the restriction indication, the processing system is configured to cause the central network node to transmit a PCI configuration of the cell that is in accordance with a PCI value of the plurality PCI values that are allowed to be used for the PCI configuration of the cell.

25. The central network node of claim 21, wherein the cell is indicated using a cell identifier.

26. The central network node of claim 25, wherein the cell identifier is a PCI value that is in accordance with the restriction indication.

27. The central network node of claim 26, wherein, to cause the central network node to transmit the PCI configuration of the cell, the processing system is configured to cause the central network node to transmit a PCI configuration of the cell that includes another PCI value that is equal to the PCI value.

28. The central network node of claim 26, wherein, to cause the central network node to transmit the PCI configuration of the cell, the processing system is configured to cause the central network node to transmit a PCI configuration of the cell that includes another PCI value that is different than the PCI value.

29. A method for wireless communication by a distributed network node, comprising:
transmitting, to a central network node, a restriction indication that indicates a restriction for a physical cell identifier (PCI) configuration of a cell that is served by the distributed network node, the distributed network node being associated with an integrated access and backhaul node; and
receiving, from the central network node, a PCI configuration of the cell that is in accordance with the restriction indication.

30. A method for wireless communication by a central network node, comprising:
receiving, from a distributed network node associated with an integrated access and backhaul node, a restriction indication that indicates a restriction for a physical cell identifier (PCI) configuration of a cell that is served by the distributed network node; and
transmitting, to the distributed network node, a PCI configuration of the cell that is in accordance with the restriction indication.
